(19) United States
(12) Patent Application Publication
(10) Pub. No.: US 2023/0183495 A1
(43) Pub. Date: Jun. 15, 2023

(54) Method and Composition for Treatment of Nets for Aquaculture

(71) Applicant: Lonza, LLC, Morristown, NJ (US)

(72) Inventors: Paul Kappock, Cumming, GA (US); Brittany Caldwell, Gainesville, GA (US); Peter Van Aken, Betekom (BE); Jay Patel, Stone Mountain, GA (US); Kevin E. Janak, Blauvelt, NY (US); Lehong Jin, Huntersville, NC (US); Zack Hinkle, Atlanta, GA (US); Justin Mackender, McDonough, GA (US)

(21) Appl. No.: 17/607,452

(22) PCT Filed: Apr. 30, 2020
(86) PCT No.: PCT/IB2020/054108

§ 371 Date: Oct. 29, 2021

Related U.S. Application Data
(60) Provisional application No. 62/842,750, filed on May 3, 2019.

(30) Foreign Application Priority Data
May 3, 2019 (EP) 19172635.5
Jul. 9, 2019 (EP) 19185332.4
Jul. 9, 2019 (EP) 19185342.3

(51) Int. Cl. C09D 5/16; A01N 59/20; A01P 15/00

(52) U.S. Cl. CPC C09D 5/1618; A01N 59/20; A01P 15/00

(57) ABSTRACT

The present invention provides a process for treating and drying a marine or submarine textile material to inhibit biofouling thereof. The invention further provides a marine or submarine textile material with antifouling properties obtained by the process of the invention, as well as the use of an antifouling formulation according to this invention for inhibiting the biofouling of marine and submarine textile materials.

### FIELD OF THE INVENTION

The invention relates to a method for inhibiting biofouling on nets for marine aquaculture, use of the method and nets treated by the method.

### BACKGROUND OF THE INVENTION

Surfaces immersed in the seawater rapidly get covered with marine organisms, called marine biological fouling or often biofouling. Fish nets used for marine aquaculture are well-known for being subject to fouling in a very short time, resulting in lower oxygen levels within the nets and thus, affecting fish growth as well as impeding the dispersal of fish waste from the nets. For this reason, fish nets used for marine aquaculture are often coated with antifouling coatings.

In common antifouling treatment processes, the nets are dip-coated and dried via hanging in the air or in a heated air flow. These fish nets are typically large, oftentimes over 50 meters in diameter, and therefore, they are typically shipped to the “antifouling treating facility” in bundles. These bundles are then unraveled and the nets dipped into large vats of coating, or pulled through the vat. After completion of the dip treatment, the net is pulled out from the dip vat and the liquid needs to be dripped back to the treatment vat for about 2-3 hours to achieve a “drip free” net before moving to drying. Oftentimes, the working environment around the dip vats and dripping areas are contaminated with the antifouling chemicals and workers are exposed to the antifouling chemicals during these manual operations.

The nets are then hung up to dry in large silos or outdoors. The hanging up of the nets is typically performed with a crane while the net is very wet. The drying will typically take several days. Sometimes, hot air will be blown over the nets to speed up the drying process, but even then, the drying will still take about a day.

The process of applying an anti-fouling coating to these large nets via the above conventional dipping- and drying process is time consuming and expensive as it involves high coating weights relative to the net weight. Further, the coating obtained by that dipping process is often incomplete and uneven, and requires long drying times. Also, the coating obtained by said dipping process will be a surface-only-coating, which will erode away faster underwater, so that the antifouling coatings obtained by the dipping process typically last only for about 3-6 months.

JP 5 732 639 B1 relates to a copper pyrithione aggregate and its use.

JP H08 319203 A discloses bis(dimethyldithiocarbamoyl)-ethylene-bis-dithiocarbamic acid zinc as an antifouling agent for fishing nets.

Ashraf et al., “Nano copper oxide incorporated polyethylene glycol hydrogel: An efficient antifouling coating for cage fishing net”, International Biodeterioration & Biodegradation, 2016, vol. 115, 39-48, discloses a hydrophilic nano copper oxide incorporated polyethylene glycol methacrylate hydrogel as antifouling coating for fishing net material.

JP 2006 335757 A discloses an underwater stain-proof agent containing a metal pyrithione complex compound useful as antifouling coating for ships and fishing nets.

JP 2000 281942 A discloses aqueous antifouling paint compositions, coats formed from the compositions, fishing nets coated with the compositions and an antifouling method using the compositions.

GB 131 345 A discloses a method of tanning fishing nets in which the nets are subjected to a vacuum.

WO 2013/025960 A1 relates to particles of copper pyrithione formed by reacting zinc pyrithione and a copper compound in the presence of a polymer matrix.

The present invention provides a process for endowing marine and submarine textile material such as large fishing nets with an antifouling activity against fouling organisms present in aquatic environments that overcomes the disadvantages of the dipping treatment described above.

The inventors have surprisingly found a process for efficiently treating fishing nets with an antifouling formulation that penetrates into the strands of the net material. As such, the antifouling formulation is homogeneously impregnated into the structure of the net rather than merely applied onto the surface or penetrating only partially or inhomogeneously into the nets as with the conventional dipping process. This uniform antifouling coating obtained by the process of the invention will last for a longer period of time than the antifouling coating obtainable by the conventional dipping process. As a further advantage, the process of the invention allows for treating the nets while still in a bundle (i.e., without unravelling the net bundle) and being treated in an enclosed vessel, which is considerably less time consuming and less process handling than the dipping process of the prior art. It provides workers of less direct contact with the antifouling formulation, which may be toxic.

As another advantage, the process provides a “drip-free” net application of the antifouling formulation, because applying the antifouling formulation via the process of the invention removes most of excess amount of coating solution during a final vacuum step and yields the treated net with significantly less drippage, i.e. in a “drip-free” condition ready to dry. The process of the invention avoids the 2-3 hours of dripping time required from conventional dip treatment.

The process according to the present invention provides for a reduced biocidal surface load while maintaining similar performance in use, and a surprisingly improved macro and/or micro distribution of the antifouling formulation after treatment over the conventional dip treatment. Due to the lower amount of antifouling formulation required, the process of the invention allows for a lower overall weight of the net.

The invention further provides a highly efficient drying process that allows for drying the nets in bundles, and dry nets can be obtained in about 1 hour. This drying process can be either done in the same treatment vessel as a continuing process or can be operated in a separate drying vessel/chamber. This is particularly advantageous for commercial, big scale applications.

### SUMMARY OF THE INVENTION

The present invention provides a process for treating and drying a marine or submarine textile material to inhibit biofouling thereof. The invention further provides a marine or submarine textile material with antifouling properties obtained by the process of the invention, as well as the use of an antifouling formulation according to this invention for inhibiting the biofouling of marine and submarine textile materials.

### BRIEF DESCRIPTION OF THE DRAWINGS

FIG. 1 depicts the particle size distribution profile of an antifouling formulation according to this invention.

FIGS. 2-4 show pictures of the nets treated by the process of the invention, and control nets for comparison, after 2, 4 and 6 months, respectively, of immersion to sea water.

FIGS. 5-16 depict the analytical data of optical image, SEM image, Cu distribution map and EDS line scan results for each of the net samples 1-12.

FIGS. 17 and 18 show the temperature and pressure/vacuum profile as a function of time, of drying textile materials according to this invention.

### DETAILED DESCRIPTION

The abbreviations used in the present specification are as follows: The term “negative pressure” (“VAC”) as used herein refers to a pressure lower than atmospheric pressure, i.e. lower than about 101.325 kPa.

The term “positive pressure” (“PP”) as used herein refers to a pressure higher than atmospheric pressure, i.e. higher than about 101.325 kPa.

Cu₂O—copper(I) oxide, CAS No. 1317-39-1
CuPT—copper pyrithione, copper 2-pyridinethiol-1-oxide, e.g., CAS [154592-20-8]
Cu(ETFAA)₂—copper di(ethyl 4,4,4-trifluoroacetoacetate)
DCOIT—4,5-dichloro-2-n-octyl-4-isothiazolin-3-one, CAS [64359-81-5]
Darvan #1®: sodium Polynaphthalene Sulfonate, dispersing agent by Vanderbilt Minerals, LLC
Attapulgite clay: hydrous magnesium-aluminum silicate, CAS [012174-11-7]
Texanol®-2,2,4-trimethyl-1,3-pentandiolmonoisobutyrat, CAS [25265-77-4]
Ethacryl® G—aqueous solution of polycarboxylate ether, high-performance aqueous dispersant

### Tralopyril—CAS [122454-29-9]

Zineb—Zinc ethylenebisdithiocarbamate CAS [12122-67-7]
Zinc dimethyldithiocarbamate—CAS [137-30-4]
Zinc diethyldithiocarbamate—CAS [14324-55-1]

The present invention provides a process for treating a marine or submarine textile material to inhibit biofouling thereof, comprising the steps of (a) subjecting said textile material to a negative pressure treatment VAC in a vessel; (b) contacting said textile material with an antifouling formulation comprising micronized particles of one or more biocidal agents, and (c) subsequently, releasing said negative pressure VAC. Step (a) can be performed before step (b), or simultaneously, or step (b) may be performed before step (a). The textile material may be in form of any textile material used for marine or submarine purposes, such as a yarn, rope, net, woven, knitted, or nonwoven fabric etc. Preferably, the textile material is a fish net. The vessel may be any suitable vessel for that purpose, e.g., a stainless steel pressure cylinder for horizontal loading, or a stainless steel industrial vessel for top-loading, and the like.

In the process of the invention, said negative pressure treatment VAC in step (a) comprises applying an initial vacuum. Said initial vacuum VAC comprises applying a vacuum of less than 101.325 kPa, preferably of about 85 kPa or less, more preferably of about 50 kPa or less, and most preferably of about 30 kPa, or less.

The negative pressure treatment VAC is typically applied for a sufficient time to remove the air from the textile material.

Subsequently, said textile material is contacted with an antifouling formulation in a step (b). The antifouling formulation used in step (b) comprises micronized particles of one or more biocidal agents, for example copper and zinc based biocides and other commonly used antifouling biocides. In one embodiment, the one or more biocidal agent is selected from copper(I) oxide (Cu₂O), copper 2-pyridinethiol-1-oxide (copper pyrithione, CuPT), tralopyril, 4,5-dichloro-2-n-octyl-4-isothiazolin-3-one (DCOIT), zinc ethylenebisdithiocarbamate, zinc dimethyldithiocarbamate, or zinc diethyldithiocarbamate. In a preferred embodiment, the one or more biocidal agent is selected from the group consisting of copper(I) oxide (Cu₂O), copper 2-pyridinethiol-1-oxide (copper pyrithione, CuPT), tralopyril, 4,5-dichloro-2-n-octyl-4-isothiazolin-3-one (DCOIT), zinc ethylenebisdithiocarbamate, zinc dimethyldithiocarbamate, and zinc diethyldithiocarbamate. In a more preferred embodiment, the one or more biocidal agent is selected from the group consisting of Cu₂O and CuPT. In a most preferred embodiment, the biocidal agents are Cu₂O and CuPT.

The micronized particles of said of one or more biocidal agents have a mean particle size of about 0.01 μm to about 25 μm, more preferably of about 0.1 μm to about 10 μm, and most preferably of about 0.3 μm to about 8 μm, and/or

a laser scattering particle size distribution having a d50 value of about 0.5 μm to about 1 μm, preferably of about 0.7 μm to about 0.9 μm; and/or
a laser scattering particle size distribution having a d90 value of less than about 5 μm, preferably of less than about 3 μm, more preferably of less than about 1.5 μm, and/or
a laser scattering particle size distribution having a d99 value of less than about 10.0 μm, preferably of less than about 8 μm, more preferably of less than about 6.0 μm, most preferably of less than about 5.5 μm.

In the process of the invention, the amount of Cu₂O in the antifouling formulation of step (b) is from about 25 wt % to about 0.5 wt %, preferably from about 20 wt % to about 5 wt %, more preferably from about 15 wt % to about 10 wt %, and most preferably from about 13 wt % to about 11 wt %.

In the process of the invention, the ratio of Cu₂O (wt %) to CuPT (wt %) in the antifouling formulation of step (b) is from about 100:1 to about 1:100, preferably from about 50:1 to about 1:1, and most preferably from about 20:1 to about 1:1. In the process of invention, said antifouling formulation may further comprise an additive selected from copper di(ethyl 4,4,4-trifluoroacetoacetate (Cu(ETFAA)₂) and/or zinc oxide (ZnO). Preferably, the additive is ZnO.

The antifouling formulation is advantageously in the form of a liquid, and preferably in the form of a dispersion of the micronized particles of said of one or more biocidal agents in water or any other suitable solvent.

Typically, said contacting step (b) is performed under the same pressure VAC as in step (a), i.e., the textile material is contacted with the antifouling formulation without releasing the vacuum, e.g., by filling the vessel with said antifouling formulation. When the vacuum is released to atmospheric pressure (step c) said antifouling formulation penetrates into the textile material.

While this penetration may be effected without applying positive pressure, additional positive pressure may be applied to further the penetration. Thus, step (c) may further comprise subjecting the textile material to a positive pressure treatment PP after releasing said negative pressure VAC. The pressure applied during said positive pressure treatment PP is generally more than about 101.35 kPa, for example more than about 800 kPa, or from about 875 kPa to about 1724 kPa. The exact pressure value depends on the textile material size and packaging conditions of said material and can be readily adapted by a skilled artisan.

After the release of the pressure or vacuum of step (c) from the vessel, the antifouling formulation may be removed from the vessel (step (d)). The removed antifouling formulation may be drained back to a storage tank. After removal of the antifouling formulation, the textile material may be subjected to a further final negative pressure treatment VAC (step (e)). Said negative pressure treatment VAC comprises applying a vacuum. Preferably, the pressure applied during said negative pressure treatment VAC is less than about 101.325 kPa, preferably of about 85 kPa or less, more preferably of about 50 kPa or less, and most preferably of about 30 kPa, or less. This ensures that the textile material is dripping free and thus can be conveniently transferred out of the vessel if warranted.

The process of the invention may further comprise an additional step (f), wherein the textile material is purged with air to assure collection of additional antifouling formulation released during step (e).

The process of the invention may further comprise a step of drying said textile material. While this step may be performed in a different vessel, it may also be conveniently performed in the same vessel as the previous steps. Said drying step comprises steam drying said textile material at about 35° C. to about 120° C., or treating said textile material with compressed hot air at a temperature of about 35° C. to about 120° C. Before treating said textile material in accordance with step, it may be beneficial that the vessel is preheated to a temperature of about 35° C. to about 120° C., i.e., to the same temperature that is applied during said drying step. During said drying step, said textile material may be subjected to a positive pressure treatment PP to push the steam into said textile materials followed by a negative pressure treatment VAC to pull the steam from the textile materials. During said drying step said steps of applying a positive pressure treatment PP followed by applying a negative pressure treatment VAC may be repeated once or twice, or even more times to create the heat movement in the said textile material bundle so achieve a fast drying. Preferably, during said drying step the steps of applying a positive pressure treatment PP followed by applying a negative pressure treatment VAC are repeated two times.

The pressure applied during said positive pressure treatment PP during drying is generally more than about 101.35 kPa, for example more than about 800 kPa, or from about 875 kPa to about 1724 kPa. The exact pressure value depends on the textile material size and packaging conditions of said material and can be readily adapted by a skilled artisan.

The pressure applied during said pressure treatment VAC during drying comprises applying a vacuum of less than about 101.325 kPa, preferably of about 85 kPa or less, more preferably of about 50 kPa or less, and most preferably of about 30 kPa, or less.

The drying step according to the invention provides the advantage of minimizing the amount of condensates on the outside of the textile material, as it allows for rapidly reaching high temperatures in the inside of the textile material so that water vapor can be removed quickly from said textile material (such as fish net bundles) in the vessel. Moreover, by drying the textile material under the conditions of the drying step according to the invention, said material maintains its color while being externally dry to the touch, but internally still damp.

The drying step according to the invention allows for a fast and efficient drying even if said textile material, e.g., fishnets, are dried in the form of bundles and is particularly advantageous for commercial, big scale applications. The time period for the drying-step can vary depending on the size and properties of the textile material, but is considerably faster than “air drying”, and is typically less than about 3 hours, more preferably less than about 2 hours, and most preferably less than about 1 hour.

The invention further provides a marine or submarine textile material with antifouling properties obtained by the process of the invention. This textile material is characterized by a homogenous copper distribution in the fibers, and a long duration of antifouling activity. It is thus particularly suited for marine and submarine use.

The invention further provides a use of an antifouling formulation as defined herein for inhibiting the biofouling of marine and submarine textile materials.

The invention further provides a use of an antifouling formulation as defined herein in the process of the invention for inhibiting the biofouling of marine and submarine textile materials.

### EXAMPLES

### Method for Determining Particle Size

The mean particle size and particle size distribution may be determined by conventional techniques know to the skilled artisan such as microscopy (SEM), sieving, sedimentation techniques, Coulter Counter, Laser Diffraction method, or permeametry technique.

### Example 1: Preparation of an Antifouling Formulation According to the Invention

TABLE 1
Preparation of a micronized Cu₂O dispersion

| Ingredients | [g] |
|---|---|
| Water | 1803 |
| Ethacryl ® G | 720 |
| Defoamer 1720 | 6 |
| Cu₂O | 3041 |
| Disperse for 20 minutes at 3000 rpm blade. Lower speed and add: | |
| Water | 400 |
| NaNO₂ | 2 |

Mix for about 5 minutes. Then bead mill for about 2 hrs.
Total: 5972 g

This Cu₂O dispersion was used for the preparation of the antifouling formulation.

TABLE 2
Preparation of the antifouling formulation*

| Ingredients | wt % | vol % |
|---|---|---|
| Cu₂O dispersion, 50 wt % Cu₂O | 25.35 | 9.54 |
| sodium polynaphthalene sulfonate | 0.05 | 0.06 |
| dispersant (Darvan #1) | | |
| CuPT powder, 98 wt % active | 2.16 | 1.53 |
| Propylene glycol | 1.35 | 1.68 |
| Hydroxyethyl cellulose | 0.13 | 0.29 |
| Attapulgite clay | 1.08 | 0.58 |
| Nepheline syenite | 1.35 | 0.67 |
| Disperse the powders at high speed (rpm) for 20 minutes, | | |
| lower speed (rpm) and add: | | |
| Acrylic emulsion 50% | 37.76 | 45.93 |
| Water | 30.20 | 38.94 |
| Texanol ® | 0.54 | 0.73 |
| Ammonia | 0.03 | 0.05 |
| Total | 100.00 | 100.00 |

*Specific gravity = 1.289, % weight solids = 36.83, % volume solids = 28

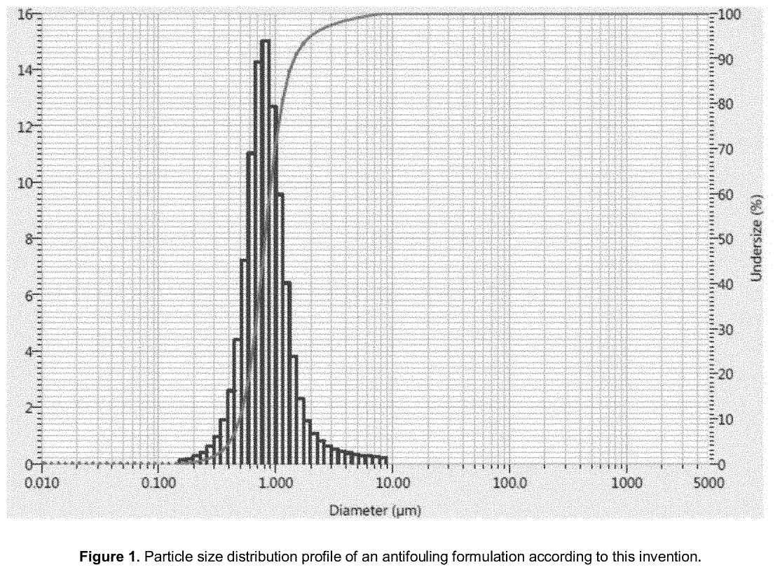

The particle size distribution profile of the antifouling formulation of Table 2 has been determined by laser scattering analysis. The resulting particle size distribution profile (particle diameter as a function of the cumulative % of particles in relation to the total sample) is depicted in FIG. 1.

The median and mean particle size was calculated from that profile to be about 0.81196 μm and about 0.98811 μm, respectively. Values for the particle diameter at selected cumulative % of particles are depicted in Table 3. The d values, in particular, d10, d50, and d90, have been calculated from the profile, representing the cumulative 10%, 50% and 90% of particles of the total sample, respectively, having a particle diameter less than the given d value. The resulting values, as can be seen from Table 3, are a d10 value of 0.4936 μm, a d50 value of 0.8120 μm, and a d90 value of 1.4562 μm.

TABLE 3
Selected values of the particle size
distribution profile of the antifouling formulation

| Cumulative % | |
|---|---|
| (x of dₓ) | Particle diameter [μm] |
| 10 | 0.4936 |
| 25 | 0.6343 |
| 50 | 0.8120 |
| 75 | 1.0600 |
| 90 | 1.4562 |
| 95 | 2.0234 |
| 96 | 2.3057 |
| 97 | 2.7678 |
| 98 | 3.5723 |
| 99 | 5.1487 |

This antifouling formulation was used in the following Examples 2 and 3.

### Example 2: Comparison of Fish Nets

The feasibility of applying the antifouling formulation to fish nets via the process of the invention (“experimental nets”) was compared to merely dipping of the nets (“control nets”) with the antifouling formulation of example 1. The fish nets employed for this comparative testing were commonly used nylon fish nets.

For the experimental nets, small sections of about 30 cm×30 cm of nylon net were cut and rolled into a bundle. The bundle was placed into an aluminum pan filled with the antifouling formulation according to Table 2. The pan was then placed into a laboratory scale pressure vessel with fittings to allow for both, pulling a vacuum and applying pressure. A vacuum of about 0 kPa was applied for a period of 30 minutes. After 30 minutes, the vacuum was released and the antifouling formulation removed by pouring it out. The net was then again subjected to a vacuum of about 0 kPa for 30 minutes to remove any antifouling formulation that had not been absorbed into the nylon. The net was then removed from the pressure vessel and allowed to dry overnight at room temperature before being unrolled.

For the control nets, small sections of nylon net were cut but not rolled. The control nets were dipped into the same antifouling formulation as used for treating the experimental net and allowed to dry.

Both, the dried control net and the dried experimental net were put on a test raft in the sea (West Palm Beach Fla.) and compared for efficacy against fouling by examination for fouling every two months for an overall period of 6 months (examination after 2, 4 and 6 months). A comparison of the antifouling formulation pickup of each treatment (experimental vs. control nets) is summarized in Table 3.

TABLE 3
Antifouling formulation pickup

| | wt. dry | wt. coated net | wt. dry coating | % wt. |
|---|---|---|---|---|
| Net | net [g] | dry [g] | pickup [g] | pickup |
| Experimental | 20.22 | 30.70 | 10.48 | 51.18 |
| net | | | | |
| Control net | 20.53 | 38.88 | 18.35 | 89.38 |

For comparison purposes, a net dipped with a formulation as used for the treatment of the experimental net and the control net but without antifouling additives has been used as a negative control (“negative control”).

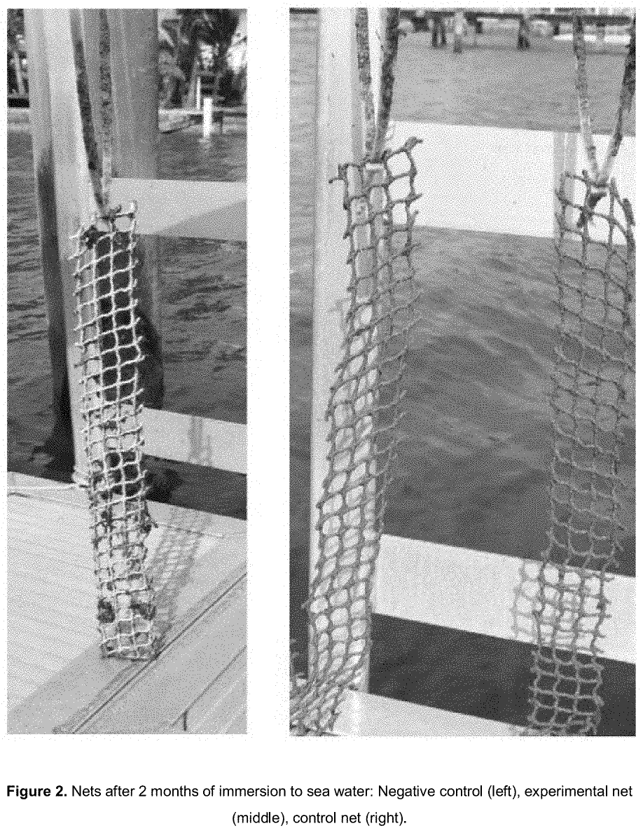

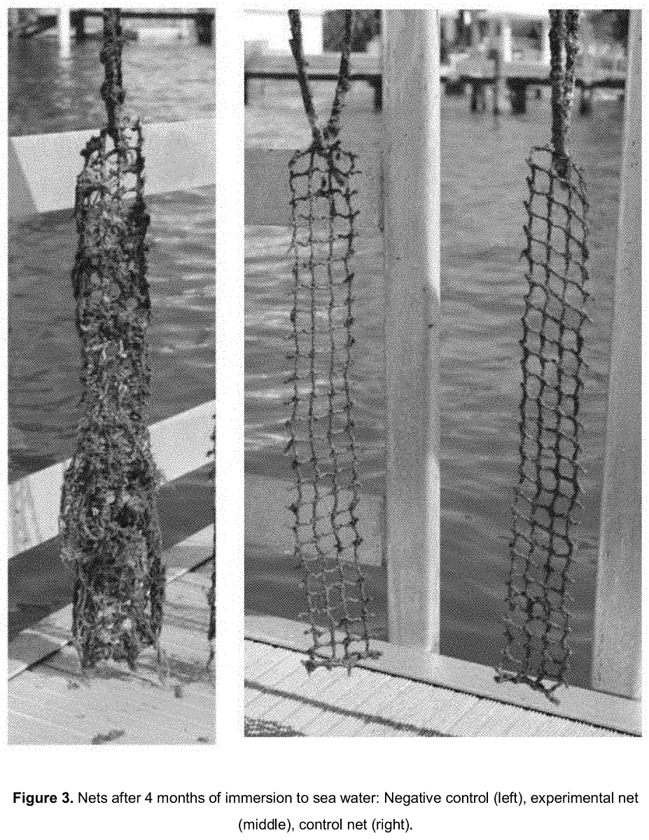

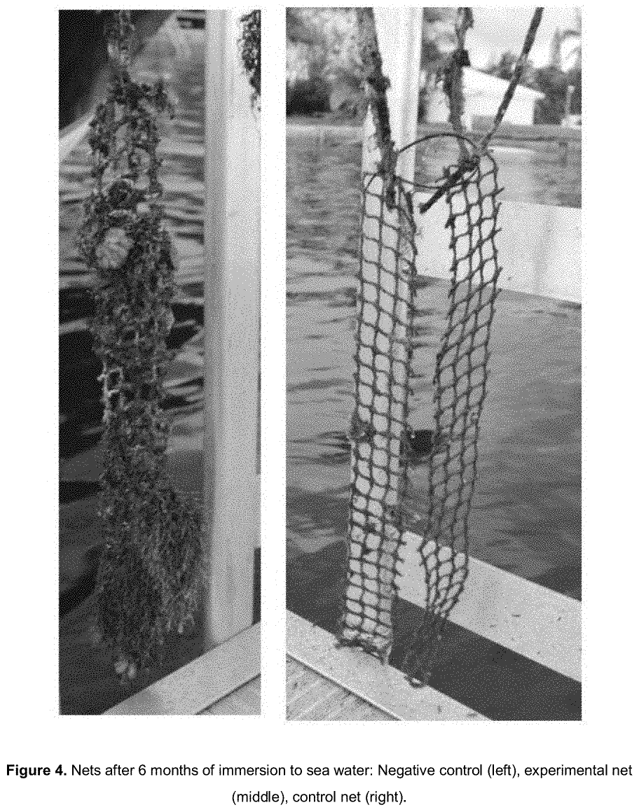

FIGS. 2-4 depict the results of the above experiment and show the respective nets after 2, 4, and 6 months immersion to sea water. Table 4 shows the ratings of the observed degree of fouling as % of surface fouled.

TABLE 4
Ratings for degree of fouling [% surface fouled]

| Net | 2 months | 4 months | 6 months |
|---|---|---|---|
| Negative control | 40 | 95 | 95 |
| Control net | 0 | 1 | 3 |
| Experimental net | 0 | 1 | 5 |

As readily derivable from Table 4 comparably clean nets are achieved after 6 months of immersion in the sea by applying the antifouling formulation via the method the invention and by the conventional dipping method.

### Example 3: Penetration Depth of Anti-Fouling Marine Coating in Fish Nets

The penetration depth of marine antifouling formulations into the fishnets was compared for two different methods of application and two different antifouling formulations. The two antifouling formulations used were the antifouling formulation of the invention (“experimental”), i.e., according to table 2, and a “competitor's” antifouling formulation (“comp”). The “competitor's antifouling formulation” is representative of typical, commercially available antifouling formulations; it is highly similar to the antifouling formulation of the present invention (“experimental”); it contains the same active agents in the same concentrations, and mainly differs from the antifouling formulation of the present invention in that the active agents are not in micronized form. The two methods compared were the vacuum process of the invention (vac, experimental) and the conventional dipping method (dip, comp).

TABLE 5
Samples tested for penetration depth

| | Sample ID | |
|---|---|---|
| | level of penetration | |
| | at the outer-, middle,- | |
| Sample | and inner part (core) | |
| No. | of the net bundle | Description |
| 1 | Experimental vac outer | Fishnets vacuum treated |
| 2 | Experimental vac middle | with experimental anti-fouling |
| 3 | Experimental vac core | formulation of the invention |
| 4 | Experimental dip outer | Fishnets dip treated with |
| 5 | Experimental dip middle | experimental anti-fouling |
| 6 | Experimental dip core | formulation of the invention |
| 7 | Comp vac outer | Fishnets vacuum treated with |
| 8 | Comp vac middle | competitor’s anti-fouling |
| 9 | Comp vac core | formulation |
| 10 | Comp dip outer | Fishnets dip treated with |
| 11 | Comp dip middle | competitor’s anti-fouling |
| 12 | Comp dip core | formulation |

“outer” refers to the outer part of a net bundle, “middle” refers to the middle part of a net bundle, and “core” refers to the inner part of a net bundle.

The anti-fouling coating penetration depth of each sample was analyzed based on optical images, SEM EDS mapping and line scan results.

Optical microscopy. Fishnet strands were wrapped with carbon tape and cross-sections were cut. The carbon tape was used to avoid fraying and to maintain the shape of the bundled strands during cutting.

Elemental analysis: Scanning electron microscopy (SEM) with energy dispersive spectroscopy (EDS) was used to analyze the elemental composition. Cross-sectional fishnet strands were mounted on carbon tape attached to an SEM metal stub. A 20 nm layer of Au/Pd was sputtered on the samples to increase electron conductivity.

The optical images were taken on the full cross-section of each fishnet sample. EDS mapping and line scan on Cu elemental distribution were performed at a magnification of 120×, which illustrates the Cu concentration from the strand outer surface towards center. In an EDS Cu distribution map, a higher Cu concentration is indicated by a brighter spot in the map. In an EDS line scan result, a higher Cu concentration is indicated by a higher Cu count at a certain distance. This is shown through a graph of the counts versus distance from the outer surface.

The fishnet coating penetration depth/limit is indicated by a sudden decrease of Cu concentration from the strand outer surface towards its center, by both EDS mapping and line scan. Graphs where the overall count intensities dip sharply as the distance from the outside edge increases show that the anti-fouling coating did not penetrate into the fishnet. Graphs where the overall count intensities stay relatively the same as the depth increases show that the anti-fouling coating did penetrate.

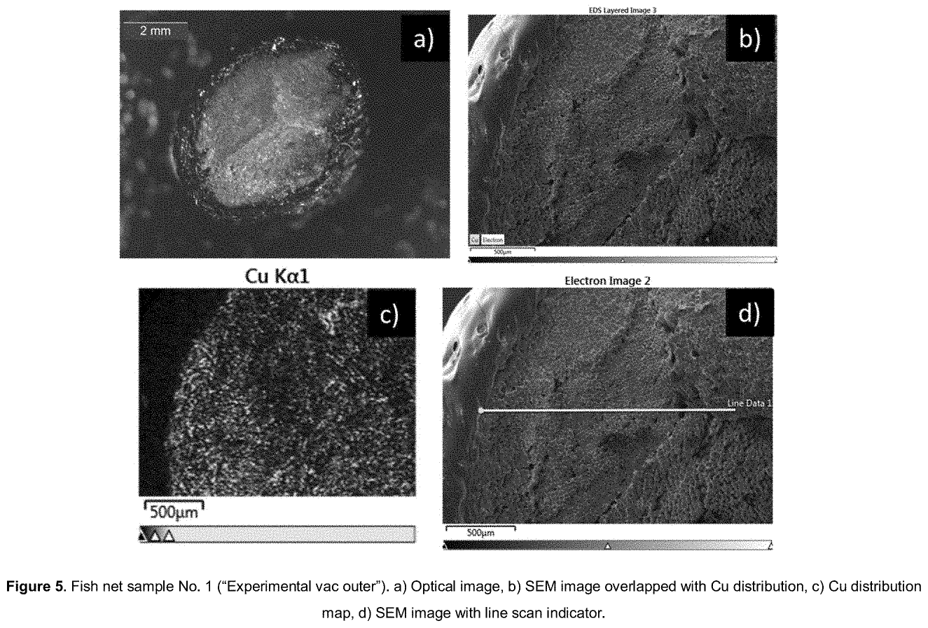

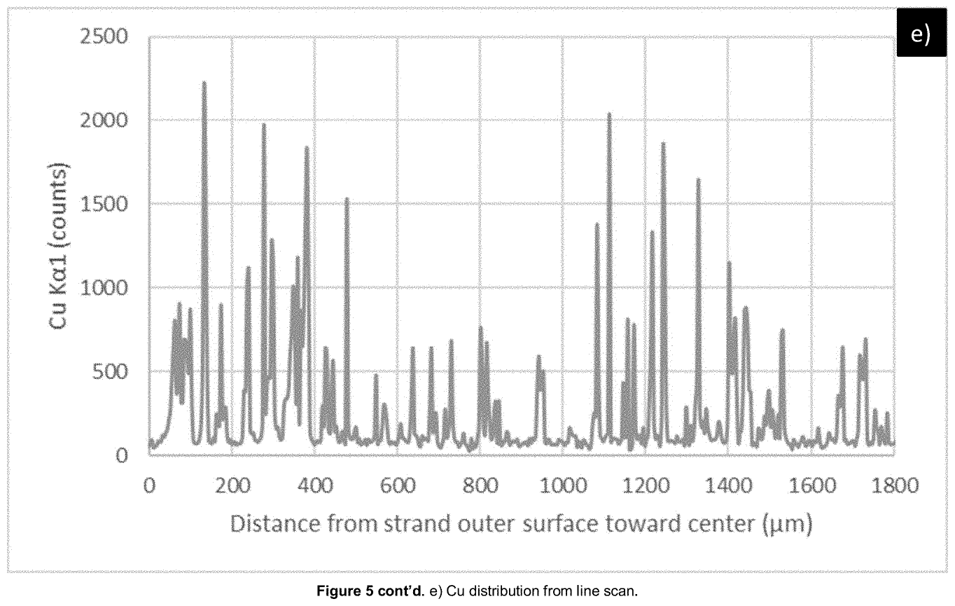

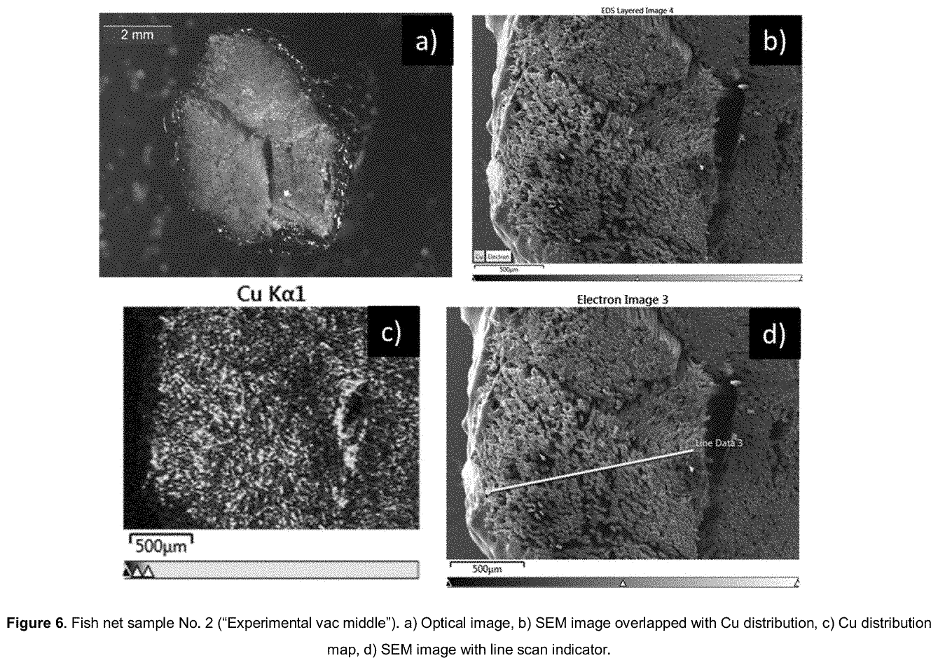

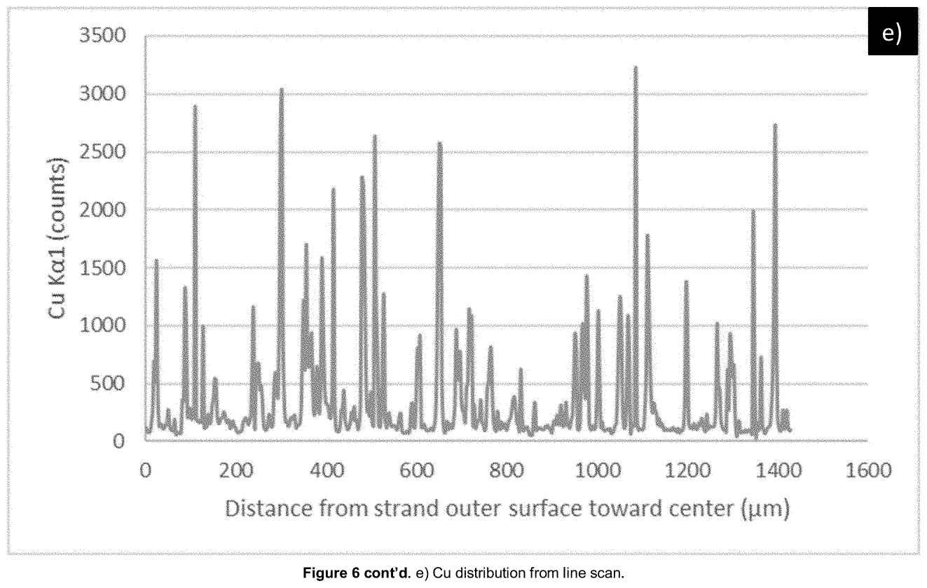

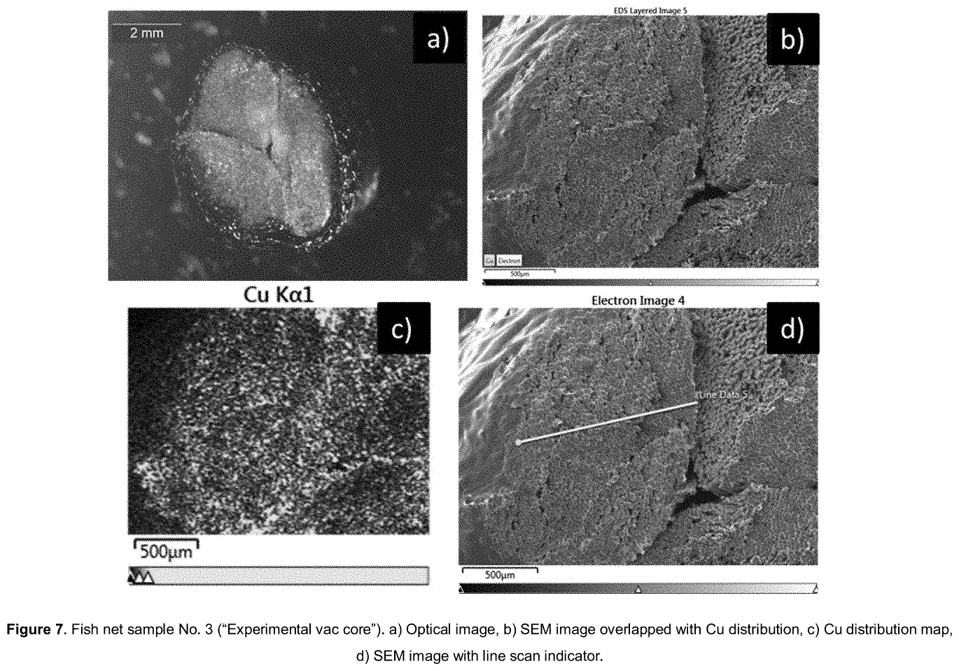

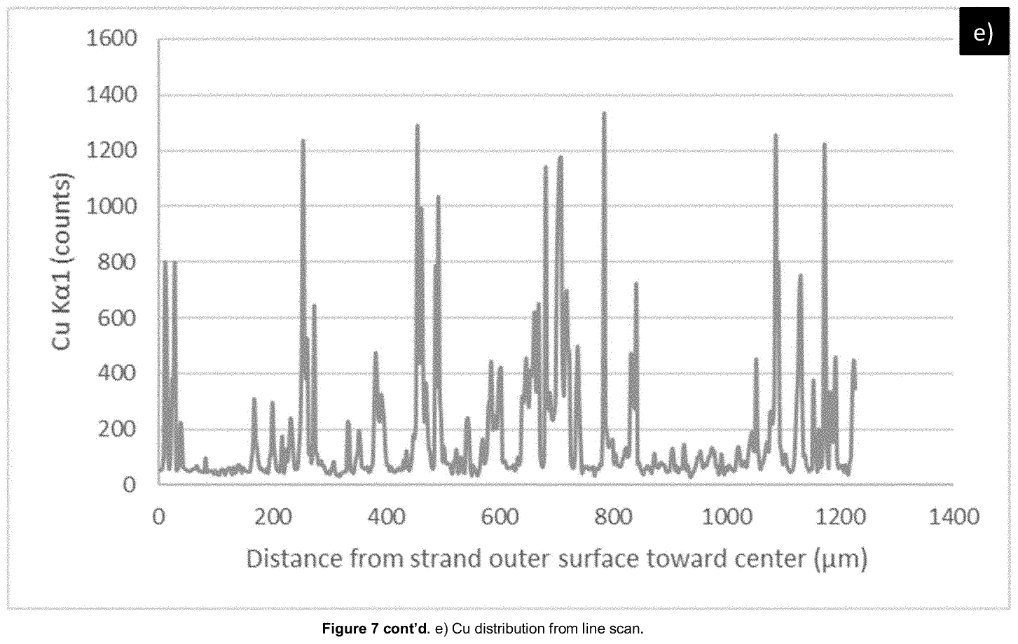

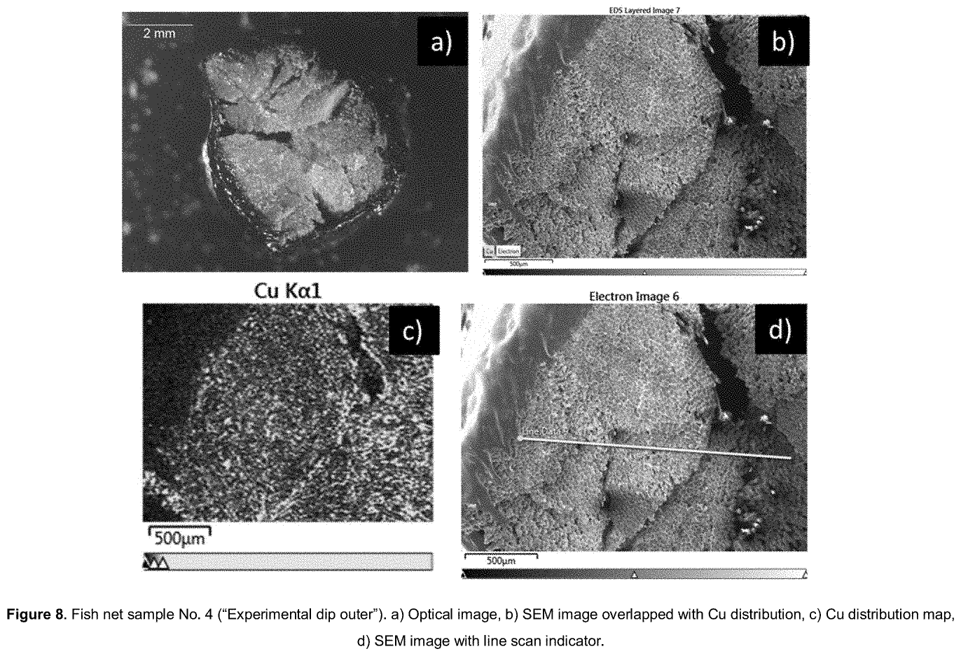

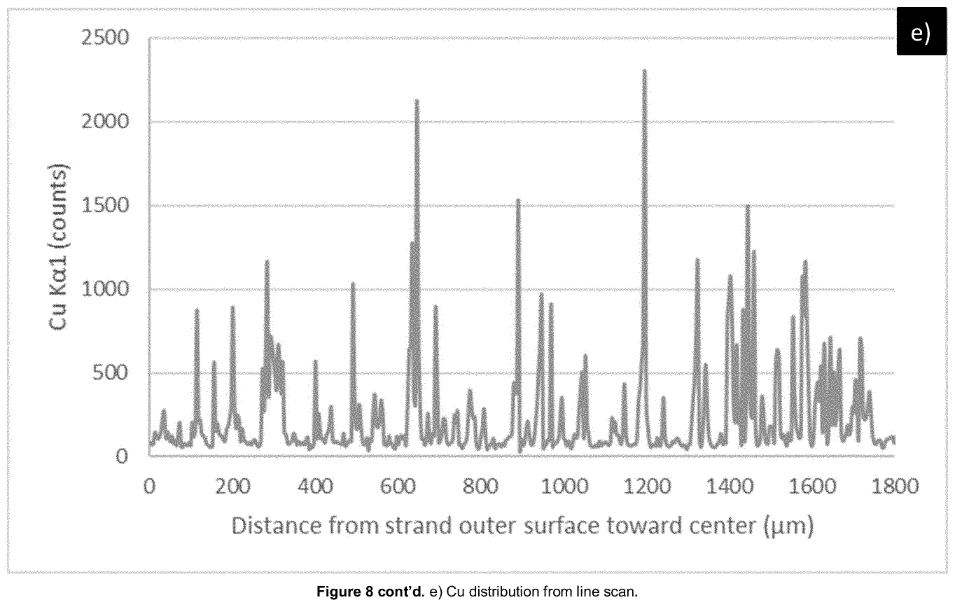

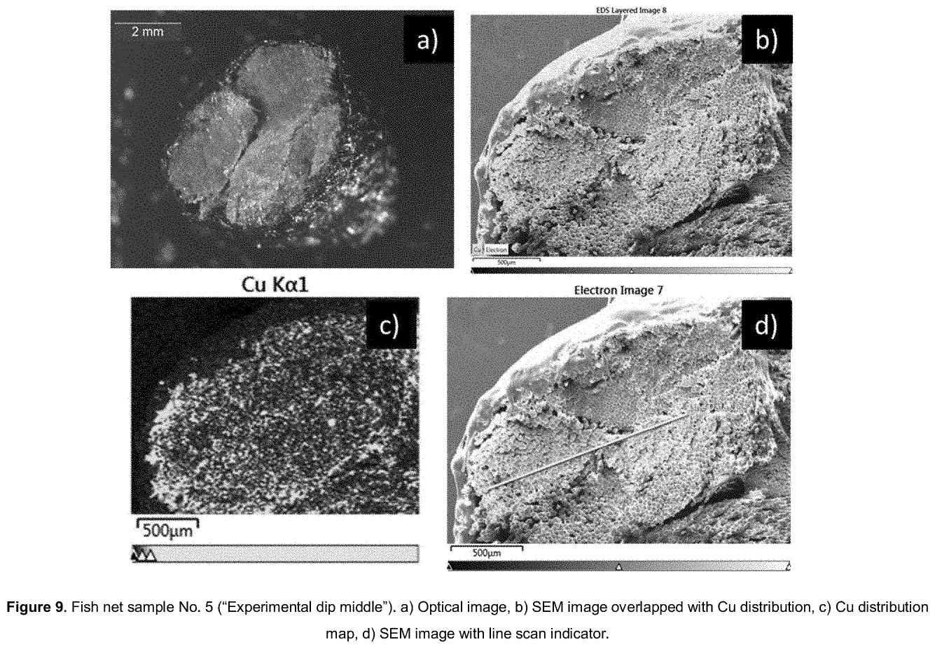

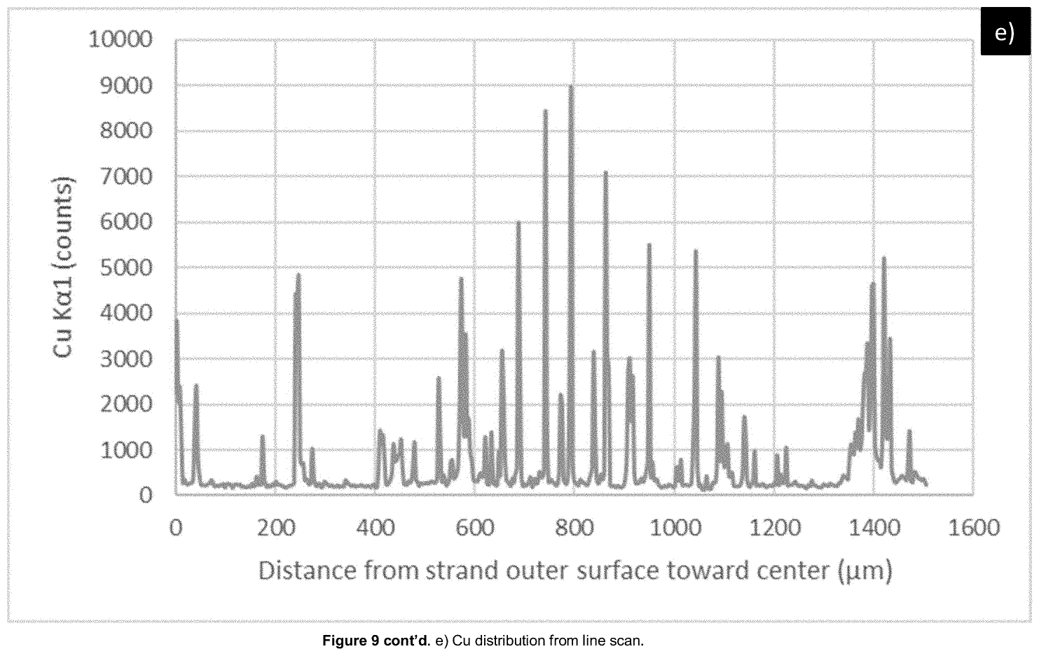

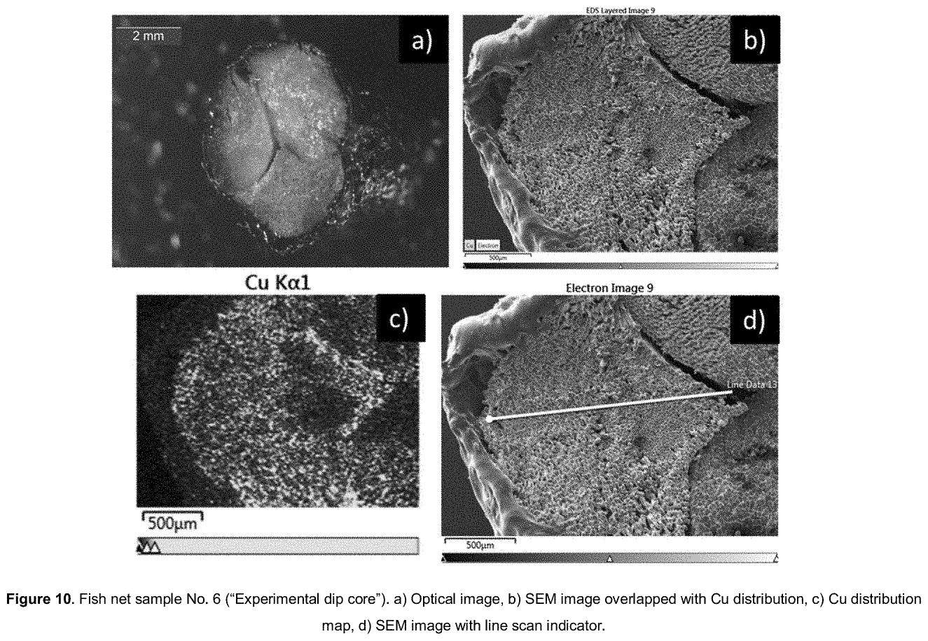

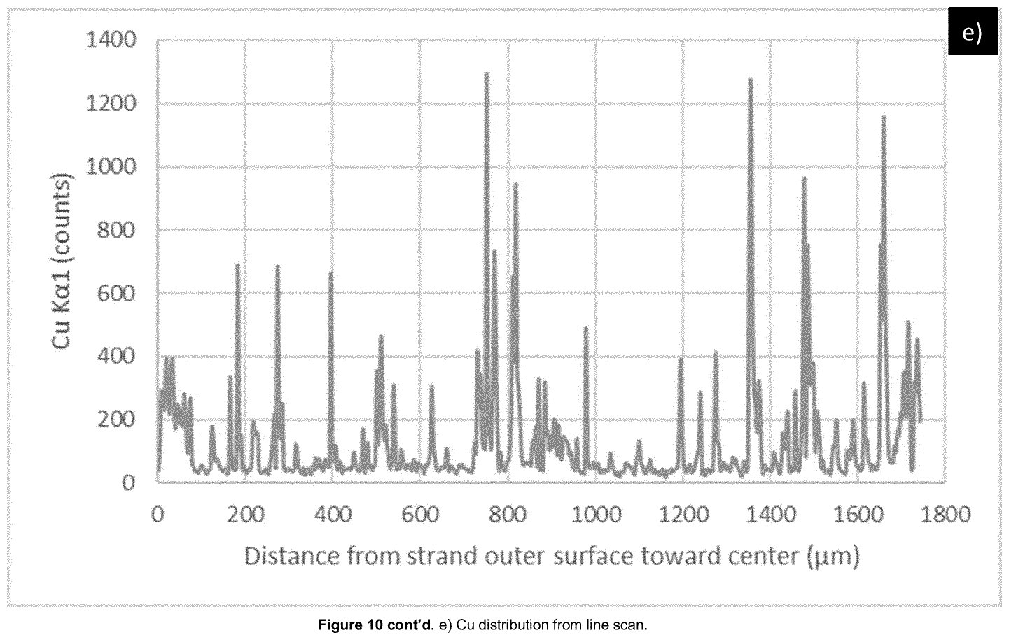

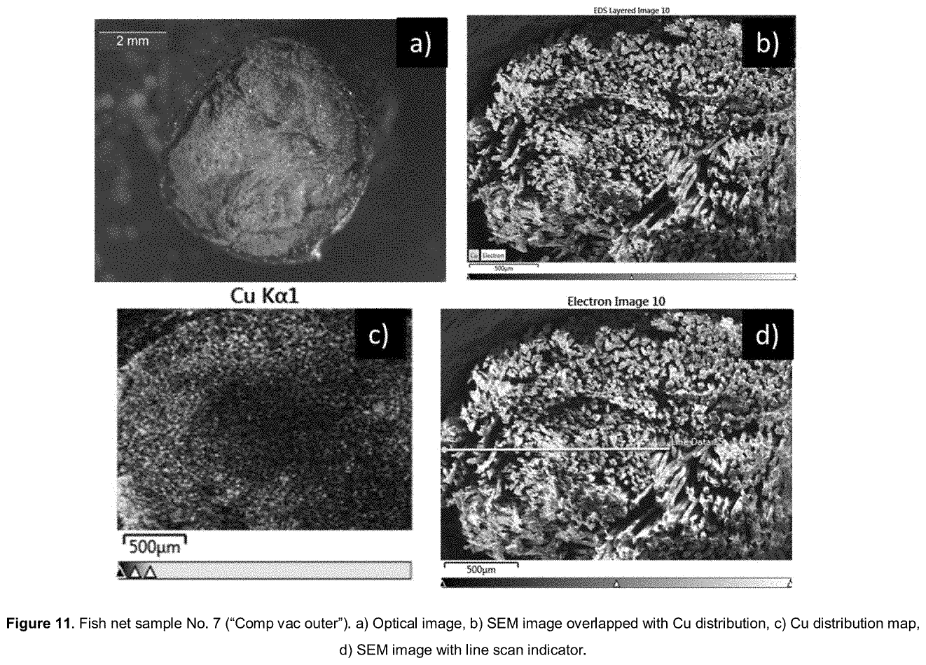

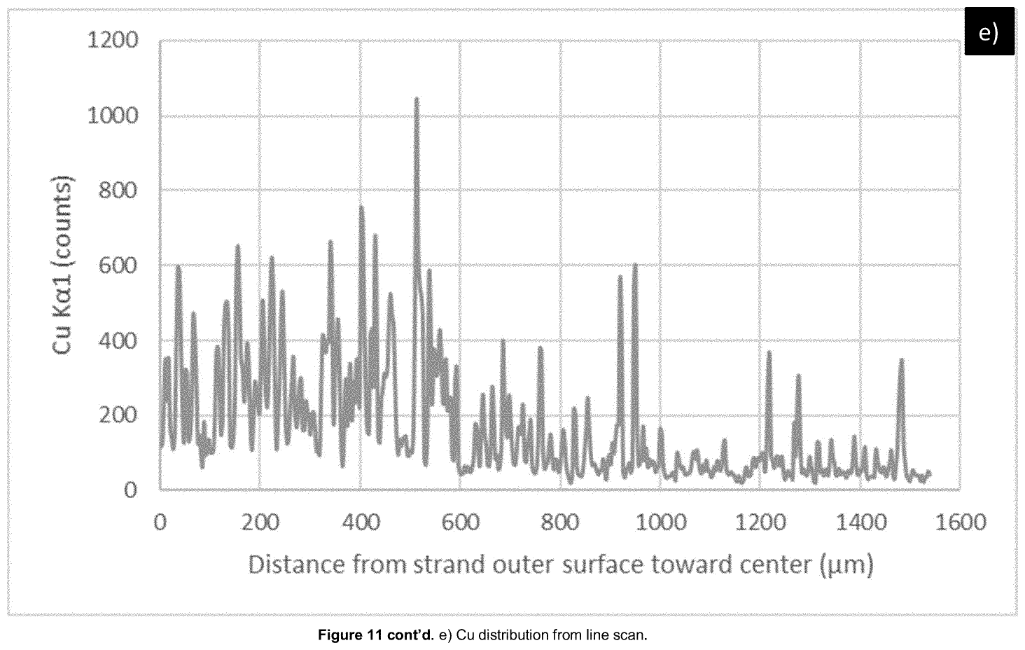

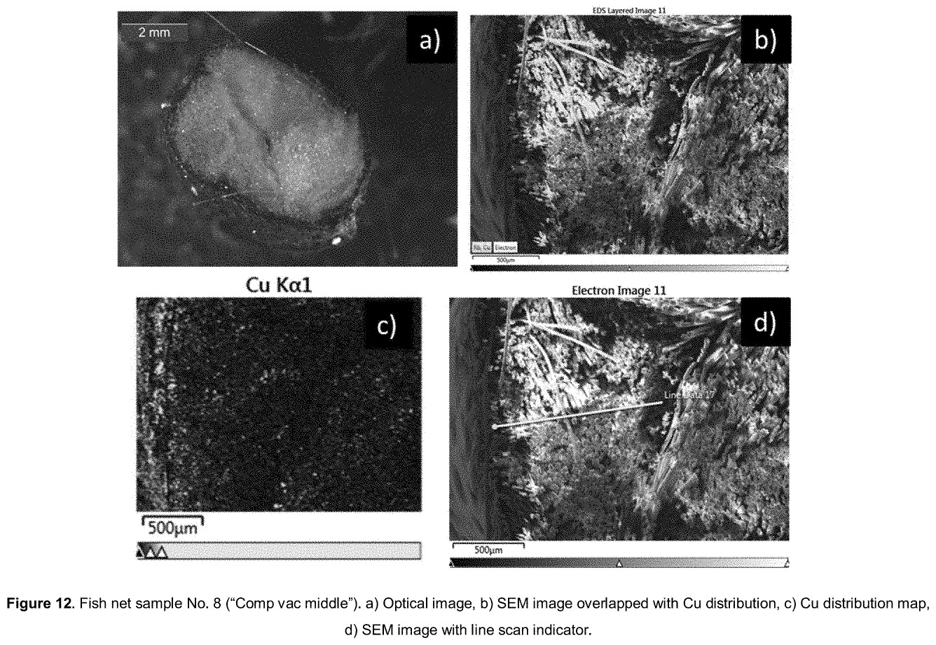

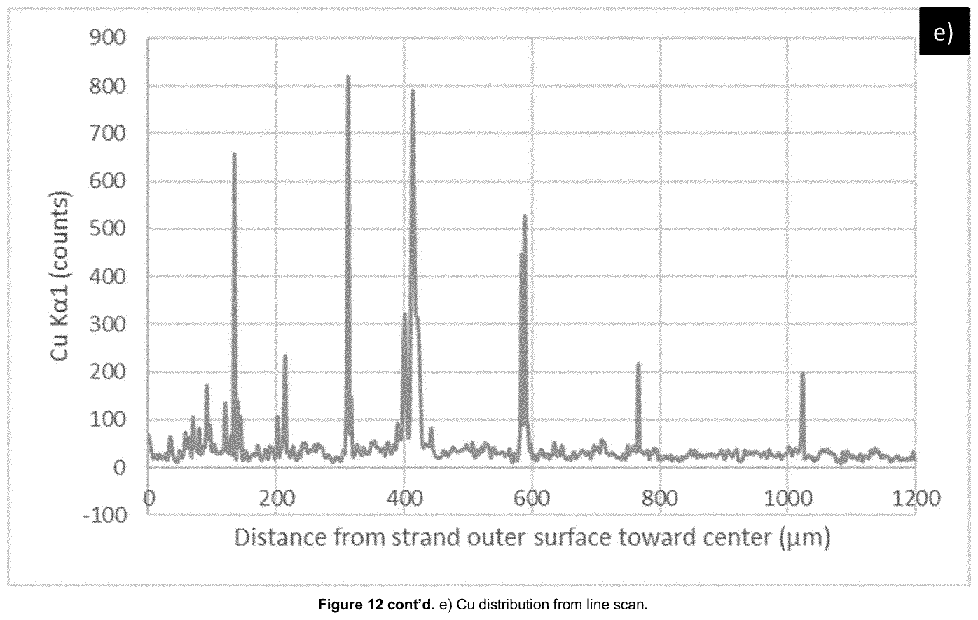

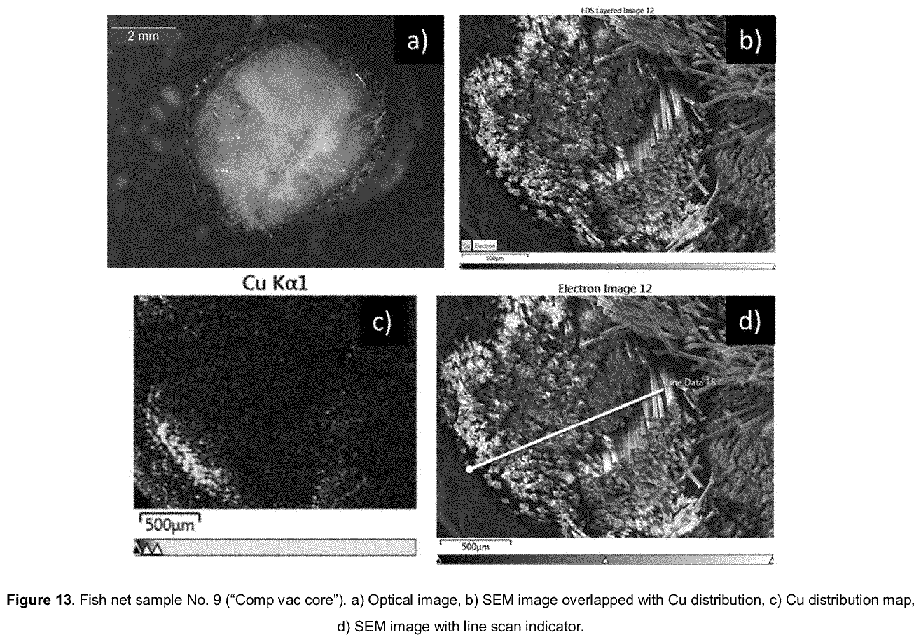

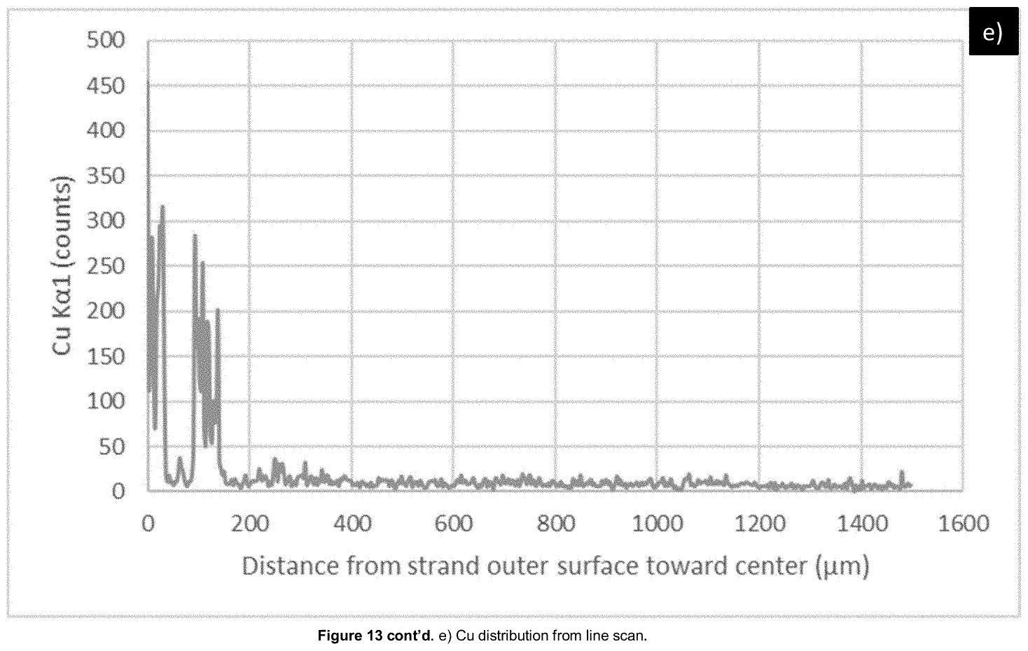

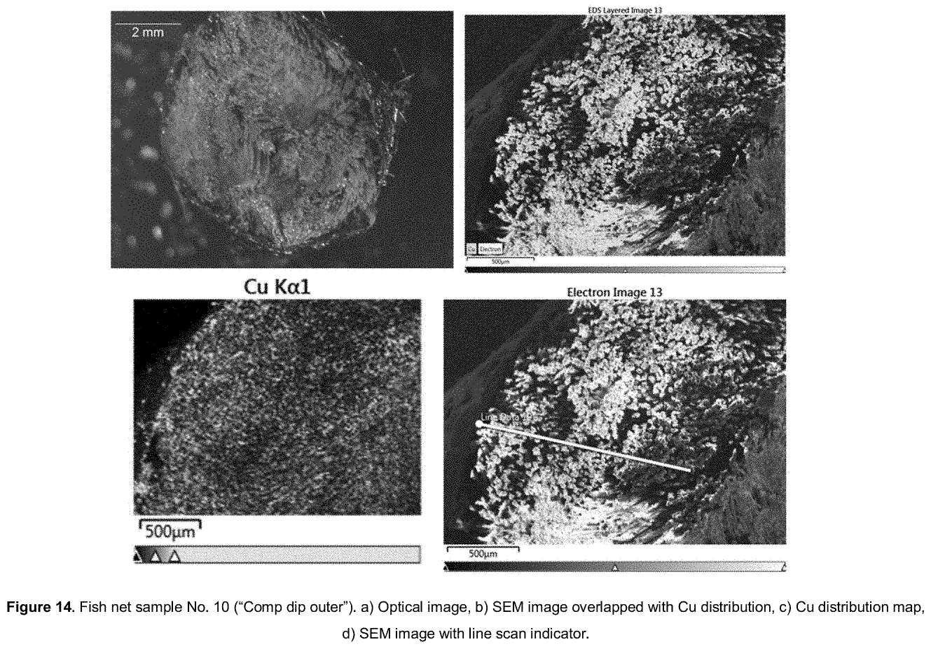

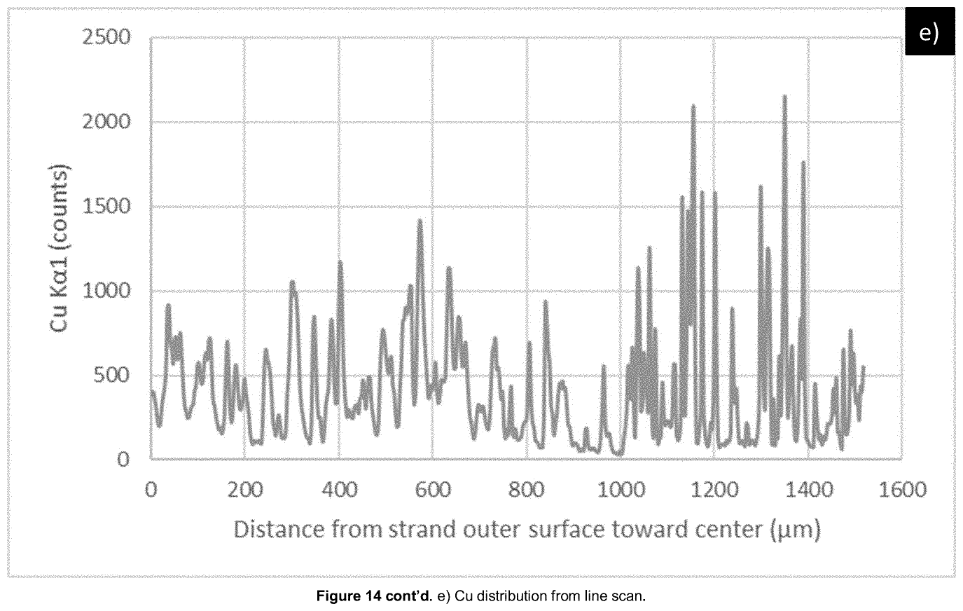

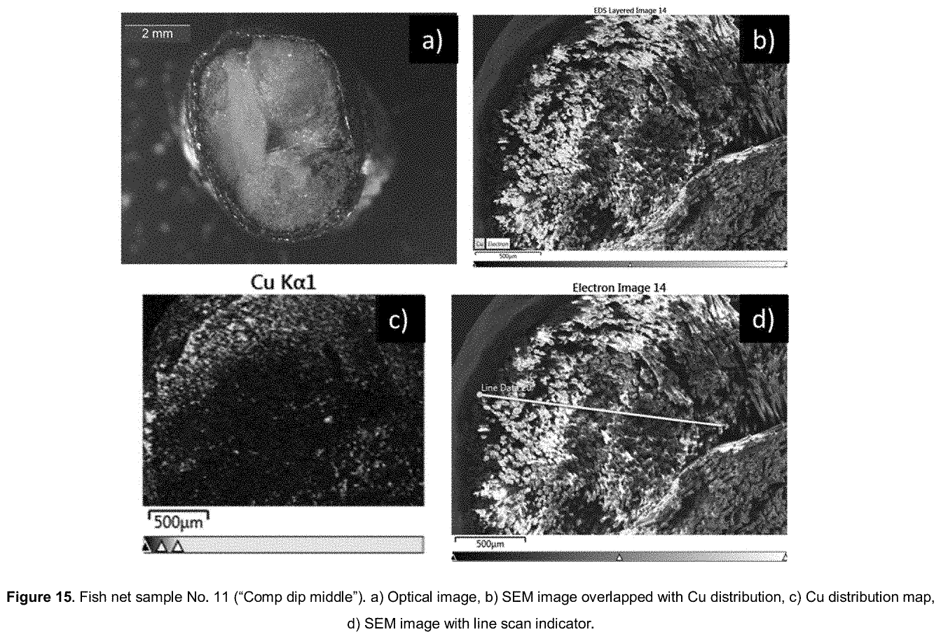

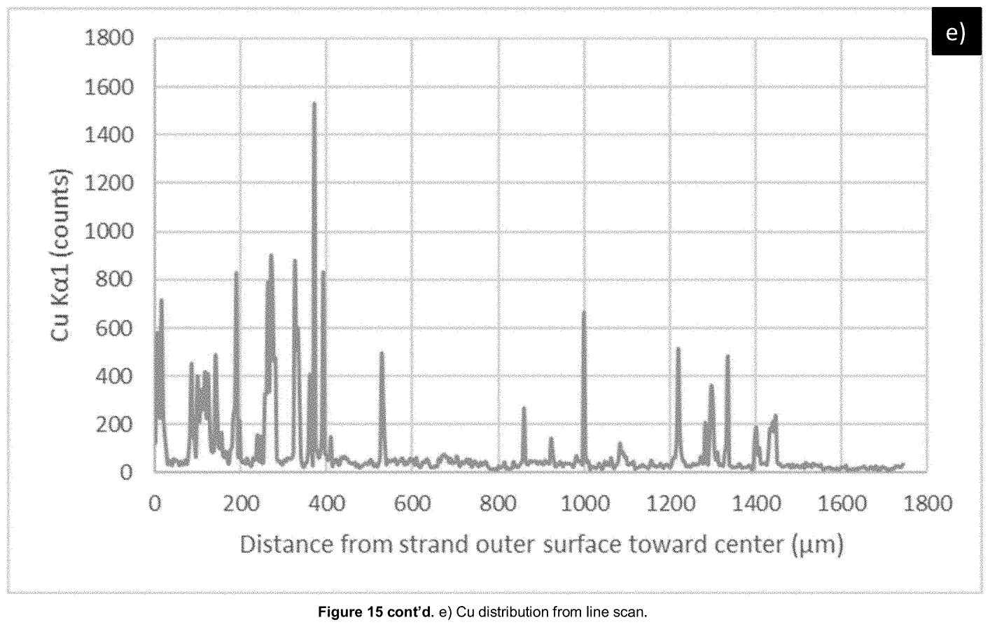

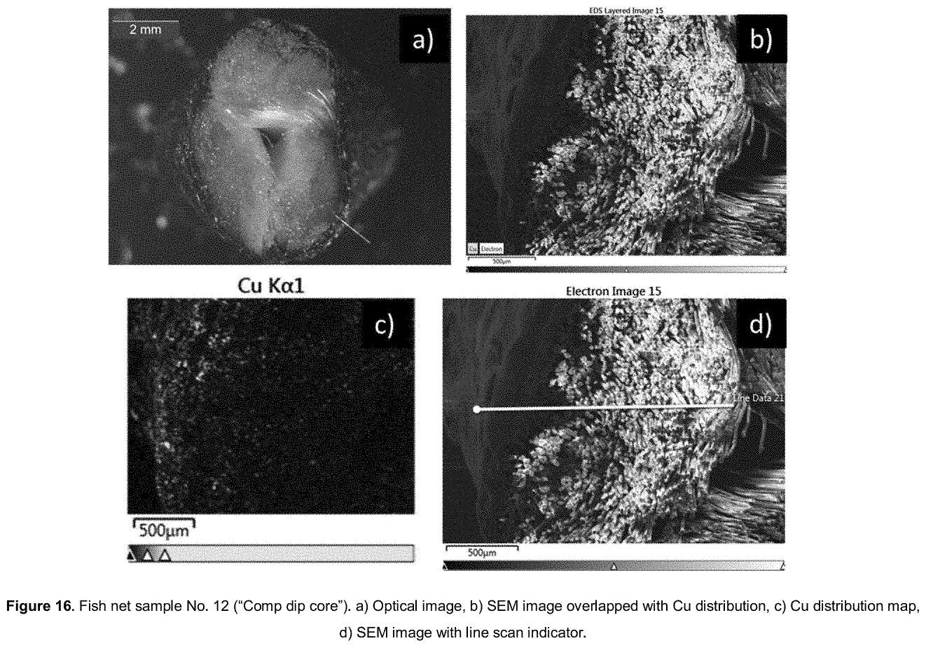

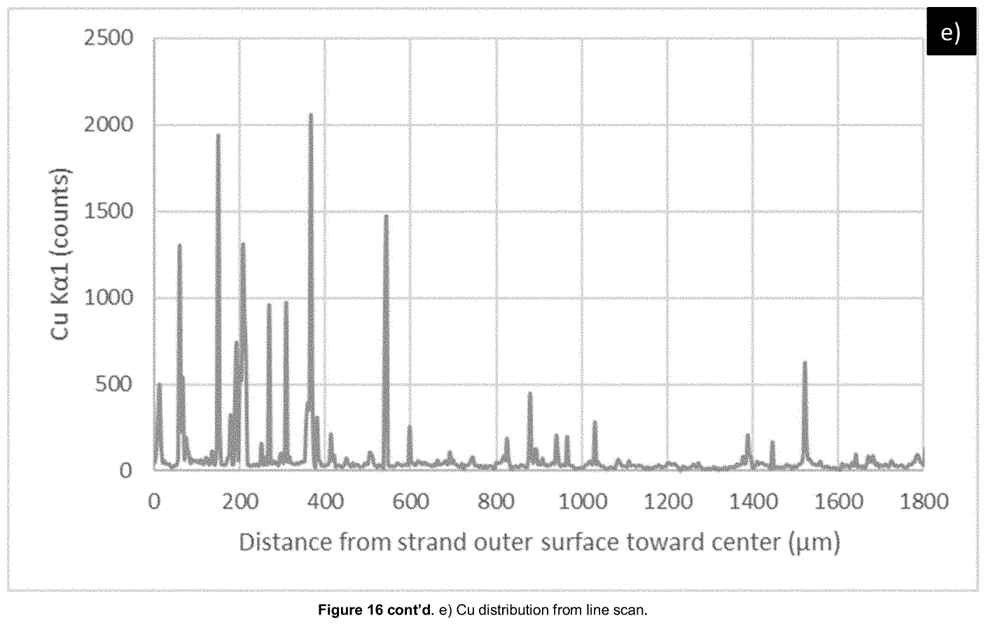

FIGS. 5-16 show the analytical data of optical image, SEM image, Cu distribution map and EDS line scan results for each of the fishnet samples No. 1-12. Table 6 summarizes the results of the anti-fouling coating penetration depth measurement for each of samples 1-12.

TABLE 6
Anti-fouling formulation penetration depth results

| | Sample ID | |
|---|---|---|
| | (level of penetration | |
| | at the outer-, middle,- | |
| Sample | and inner part (core) | Anti-fouling coating |
| No. | of the net bundle | penetration depth results |
| 1 | Experimental vac outer | Thoroughly penetrated, and |
| | | homogeneous |
| 2 | Experimental vac middle | Thoroughly penetrated, and |
| | | homogeneous |
| 3 | Experimental vac core | Thoroughly penetrated, and |
| | | homogeneous |
| 4 | Experimental dip outer | Thoroughly penetrated, but |
| | | inhomogeneous |
| 5 | Experimental dip middle | Thoroughly penetrated, but |
| | | inhomogeneous |
| 6 | Experimental dip core | Thoroughly penetrated, but |
| | | inhomogeneous |
| 7 | Comp vac outer | Sudden decrease at >600 μm |
| | | from the outer surface |
| 8 | Comp vac middle | Sudden decrease at >400 μm |
| | | from the outer surface |
| 9 | Comp vac core | Sudden decrease at >200 μm |
| | | from the outer surface |
| 10 | Comp dip outer | Thoroughly penetrated, but |
| | | inhomogeneous |
| 11 | Comp dip middle | Sudden decrease at >400 μm |
| | | from the outer surface |
| 12 | Comp dip core | Sudden decrease at >400 μm |
| | | from the outer surface |

“outer” refers to the outer part of a net bundle, “middle” refers to the middle part of a net bundle, and “core” refers to the inner part of a net bundle.

As readily derivable from Table 6 only the samples treated according to the invention (experimental vac, samples No. 1-3) are thoroughly and homogenously penetrated by the antifouling composition.

### Example 4: Steam Drying of Nets

A commercial Nylon net sample was cut into a 1.2 m wide and 6.1 m long segment 6 times. These net segments were folded in half and rolled into a cylinder-shaped bundle. The bundles were about 0.66 m long with a diameter of approximately 0.20 m. The antifouling formulation of example 1 was prepared and used in the following process.

The net bundles were subjected to the following vacuum/pressure/vacuum (VPV) treatment: an initial vacuum was applied for 5 minutes at 27.1 kPa, followed by introducing the antifouling formulation to the vessel. The bundles were treated with the antifouling formulation according to example 1. After releasing the vacuum, a positive pressure treatment has been applied for 15 minutes at 1034 kPa. After releasing the pressure, the remaining antifouling formulation was removed from the vessel, and a final vacuum was applied for 30 minutes at 17 kPa. The 30 minutes final vacuum time was determined based on the weight changes after 10 minutes interval during the final vacuum period. The total treatment time for each charge was less than 1 hour.

After completion, the removed antifouling formulation was stored over night for next day's use. It was noticed that there was no solid settlement in the bottom of the storage tank after 16 hours without agitation of solids from the antifouling formulation, i.e., no incompatibility was observed in solution appearance and stability.

The experimental bundle was then steam dried within the vessel using a combination of vacuum and steam. During steam drying of the experimental bundle, three temperature probes were placed inside the vessel during the experiments to monitor the rate of temperature rise. One was within the center of the bundle (T3); another was 2.54 cm below the surface of the bundle (T4); the last was placed in the empty space of the vessel (T2). Pressure within the vessel was also recorded using a pressure/vacuum transmitter.

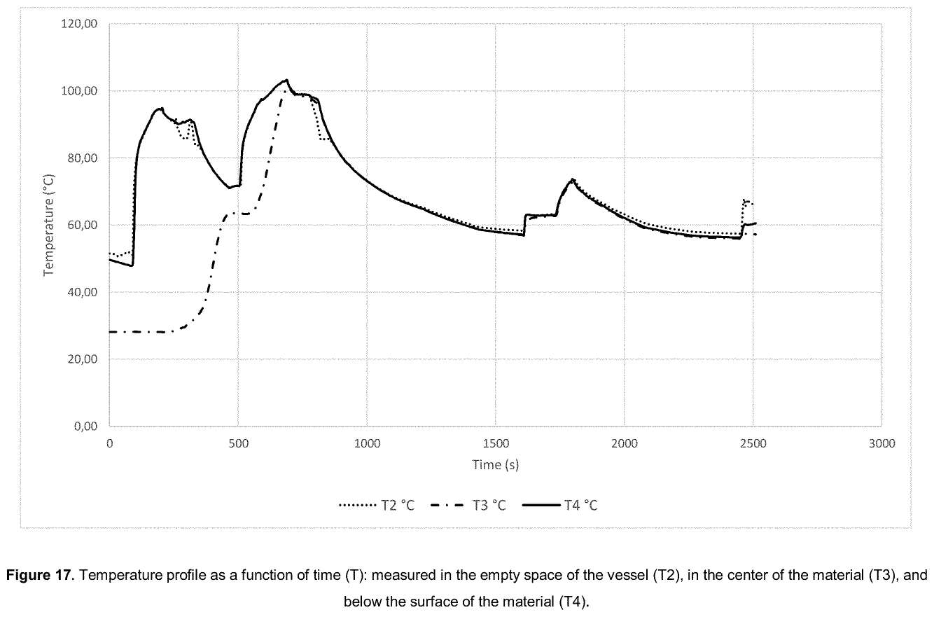

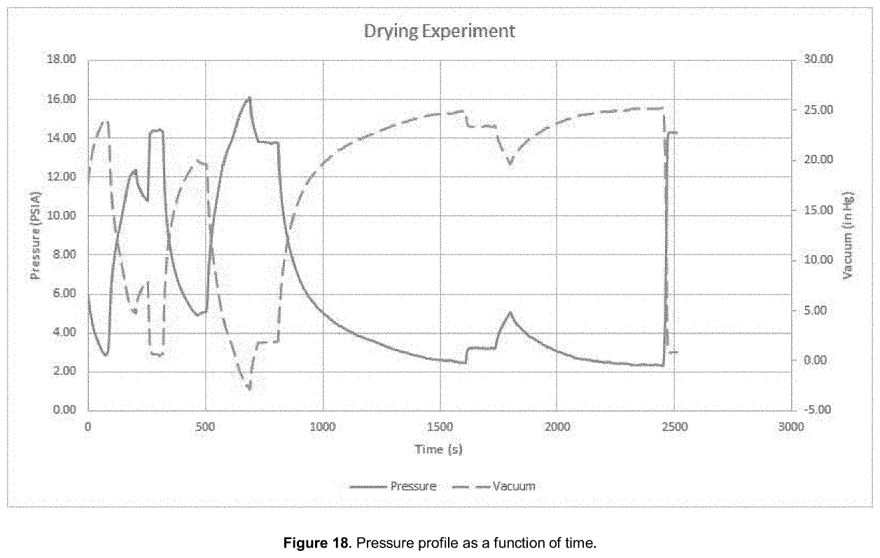

Prior to steam drying, the vessel was pre-heated with steam to a temperature of 55° C. The vacuum/vacuum treatment was then repeated two times in the steam drying process. The resulting temperature and pressure profiles of the steam drying process as a function of time are depicted in FIGS. 17 and 18, respectively. As can be seen from FIG. 17, temperatures reached near 100° C. throughout the net bundle after only 10 minutes.

During the steam drying process, the amount of condensate collected was remarkably low (less than 1 liter), and only very low amounts of biocidal agent have been removed from the antifouling formulation during the process as shown in Table 7. Further, the bundle color remained and the net exterior was very dry to the touch. Favorably, the total drying process time was less than 1 hour.

TABLE 7
Relative content of biocidal agent in antifouling
formulation and condensate (determined by XRay).

| Net | Relative Cu level |
|---|---|
| Initial | 1.00 |
| Condensate | 0.09 |

The results of the antifouling treatment of the experimental bundles with the antifouling formulation according to the invention, and subsequent steam drying as described above are summarized in trials 2 and 4 in Table 8 below. One bundle was used as a control bundle that was dried in a similar manner as the experimental bundles (i.e., with compressed air using a vacuum/pressure process) but under ambient temperature (i.e., without heating). The results for that bundle are summarized in trial 6 of Table 8.

TABLE 8
Results of drying the experimental and control bundle
(MC % moisture content)

| | MC % | |
|---|---|---|
| | remain | |
| Drying | after | % MC |
| trials | drying | reduction |
| 2 | 23.4 | 46.6 |
| 4 | 26.4 | 41.0 |
| 6 | 42.6 | 4.1 |

*6: Drying trial with compressed air under ambient temperature of about 20-25° C. using similar vacuum/pressure as in drying trial 2 and 4.

Generally, the experimental results show satisfactory solution uptake, uniform solution penetration from the outside to the inside of the net bundles, and little to no residues on the surface of the experimental net bundles, i.e. a very low amount of condensates and little to no dripping after completion of the treatment. The overall treatment for the steam drying is fast with less than about 1 hour.

The treatment solution going through repeated treatment charges showed no significant chemical and physical property changes, such as antifouling active contents, particle size distribution, viscosity and settling rates.

Further, the experimental net bundles maintained uniformed color with low amounts of condensate on the nets, and were not brittle, whereas the bundle was externally dried to the touch but internally still damp. The data clearly show that using steam drying within the vessel can remove the majority of the liquid leaving about 25% moisture after drying.

1. A process for treating a marine or submarine textile material to inhibit biofouling thereof, comprising the steps of:
a. subjecting said textile material to a negative pressure treatment VAC in a vessel;
b. contacting said textile material with an antifouling formulation comprising micronized particles of one or more biocidal agents, and
c. subsequently, releasing said negative pressure VAC;
further comprising a step of drying said textile material, wherein said drying step comprises:
steam drying said textile material at a temperature of about 35° C. to about 120° C., or treating said textile material with compressed hot air at a temperature of about 35° C. to about 120° C.

2. The process of claim 1, wherein step (c) further comprises subjecting the textile material to a positive pressure treatment PP after releasing said negative pressure VAC.

3. The process of claim 1, wherein the one or more biocidal agent is selected from copper(I) oxide (Cu₂O), copper 2-pyridinethiol-1-oxide (copper pyrithione, CuPT), tralopyril, 4,5-dichloro-2-n-octyl-4-isothiazolin-3-one (DCOIT), zinc ethylenebisdithiocarbamate, zinc dimethyldithiocarbamate, or zinc diethyldithiocarbamate.

4. The process of claim 1, wherein the antifouling formulation further comprises an additive selected from copper di(ethyl 4,4,4-trifluoroacetoacetate) (Cu(ETFAA)₂) and/or zinc oxide (ZnO).

5. The process of claim 1, wherein the micronized particles are characterized by the following:
a mean particle size of about 0.01 μm to about 25 μm; and/or
a laser scattering particle size distribution having a d50 value of about 0.5 μm to about 1 μm; and/or
a laser scattering particle size distribution having a d90 value of less than about 5 μm; and/or
a laser scattering particle size distribution having a d99 value of less than about 10.0 μm.

6. The process of claim 3, wherein the amount of Cu₂O in the antifouling formulation is from about 25 wt % to about 0.5 wt %, and/or wherein the ratio of Cu₂O (wt %) to CuPT (wt %) in the antifouling formulation is from about 100:1 to about 1:100.

7. The process of claim 1, further comprising a step (d), wherein the antifouling formulation is removed from the vessel, and/or further comprising a step (e), wherein said textile material is subjected to a further negative pressure treatment VAC, and/or further comprising a step (f), wherein said textile material is purged with air.

8. The process of claim 1, wherein during the drying step the textile material is subjected to
a positive pressure treatment PP; followed by
a negative pressure treatment VAC.

9. The process of claim 1, wherein the drying step is performed in the same vessel as steps (a) to (c).

10. The process of claim 1, wherein the pressure applied during the negative pressure treatment VAC is less than about 101.325 kPa, and/or wherein the pressure applied during the positive pressure treatment PP is more than about 101.35 kPa.

11. A marine or submarine textile material with antifouling properties obtained by the process of claim 1.

12. (canceled)

13. (canceled)

14. The process of claim 1, wherein the textile material is a fish net.

15. The textile material of claim 11, wherein the textile material is a fish net.

16. The process of claim 3, wherein the one or more biocidal agent is selected from the group consisting of Cu₂O and CuPT.

17. The process of claim 16, wherein the one or more biocidal agents are Cu₂O and CuPT.

18. The process of claim 7, wherein the drying step is performed in the same vessel as steps (a) to (c) and steps (d) to (e).
